(19) United States
(12) Patent Application Publication
(10) Pub. No.: US 2002/0194044 A1
(43) Pub. Date: Dec. 19, 2002

(54) Computerized systems and methods for performing new product introductions

(76) Inventors: Michael Robert Lablanc, Wilton, NY (US); Leonard Richard Douglas, Burnt Hills, NY (US); Mark Mitchell Kornfein, Latham, NY (US); Hui Gao, Schenectady, NY (US); Dongming Gao, Clifton Park, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/882,638

(22) Filed: Jun. 15, 2001

(51) Int. Cl. G06F 17/60

(52) U.S. Cl. 705/8

(57) ABSTRACT

Computerized systems and methods for performing an electronic new product introduction project on a global basis including a planning module operable for acquiring information related to a plurality of activities and tasks associated with the project from a plurality of individuals simultaneously, storing the information related to the plurality of activities and tasks, and transferring the information related to the plurality of activities and tasks to the plurality of individuals simultaneously. The system also including a processor operable for manipulating the information related to the plurality of activities and tasks and a communications network operable for communicating the information related to the plurality of activities and tasks to and from the plurality of individuals.

### BACKGROUND OF THE INVENTION

The present invention relates generally to computerized systems and methods for assuring process compliance for a wide array of processes and, more specifically, to web-based systems and methods for performing electronic new product introductions on a global basis.

Businesses utilize a variety of processes for bringing new products to market. These processes, often collectively referred to as new product introduction (NPI) processes, may involve the completion of a number of discrete steps, including, for example, initial product conception, product design, product manufacture, and post-shipment follow up. NPI processes may also involve a series of tollgates or go/no-go points in the developmental or distributional life cycle of a product. Each tollgate may have a set of activities or tasks associated with it. While NPI processes are often very similar, they may be customized based upon the needs of a particular business or the requirements associated with a particular product. As a result, NPI processes may vary with respect to focus, steps, nomenclature, etc.

Traditionally, businesses have kept track of NPI process steps manually on paper, or with the aid of locally accessible computer programs, such as spreadsheets. Such systems and methods, however, have several important limitations. First, manual or spreadsheet-based systems and methods are not generic and new papers or spreadsheets must be generated when new products are introduced, or when new businesses utilize existing processes. Second, such systems and methods require the assignment of a single operator, having a locally-accessible computer program, to monitor and track the progress of an NPI. Simultaneous information updates to multiple operators are not available and the coordination of product development and distribution between geographically diverse operators and teams is difficult. Third, the assurance of process compliance is difficult as such systems and methods lack the required robustness.

Thus, what is needed are globally-accessible, web-based systems and methods for performing electronic NPIs. What is also needed are systems and methods which allow team coordination and collaboration efforts to be carried out regardless of team member or work location. Further, what is needed are systems and methods which enable the integration of process compliance management and engineering data. Finally, what is needed are systems and methods capable of storing and archiving project data such that efficiency may be monitored, processes may be tracked on a macro level, recurring problems may be diagnosed, and continuous improvements may be implemented.

### BRIEF DESCRIPTION OF THE INVENTION

The present invention overcomes the above limitations and provides systems and methods for assuring process compliance for a wide array of processes, especially those involving new product introductions on a global basis.

In one embodiment, a computerized method for performing an electronic new product introduction project on a global basis includes creating the project using a globally-accessible system, creating a plurality of activities and tasks associated with the project using the globally-accessible system, selecting a plurality of individuals to perform the plurality of activities and tasks, notifying the plurality of individuals which of the plurality of activities and tasks each has been selected to perform using the globally-accessible system, collecting status information related to the plurality of activities and tasks from the plurality of individuals using the globally-accessible system, simultaneously communicating the status of the plurality of activities and tasks to the plurality of individuals using the globally-accessible system, and monitoring the progress of the project using the globally-accessible system.

In another embodiment, a computerized system for performing an electronic new product introduction project on a global basis includes a planning module operable for acquiring information related to a plurality of activities and tasks associated with the project from a plurality of individuals simultaneously, storing the information related to the plurality of activities and tasks, and transferring the information related to the plurality of activities and tasks to the plurality of individuals simultaneously. The system also includes a processor operable for manipulating the information related to the plurality of activities and tasks and a communications network operable for communicating the information related to the plurality of activities and tasks to and from the plurality of individuals.

### BRIEF DESCRIPTION OF THE DRAWINGS

FIG. 1 is a flow chart of one embodiment of a computerized method for performing electronic new product introductions on a global basis;

FIG. 2 is a schematic diagram of one embodiment of a computerized system for performing electronic new product introductions on a global basis;

FIG. 3 is a functional block diagram of one embodiment of a computer system comprising the system for performing electronic new product introductions; and

FIG. 4 is a functional block diagram of one embodiment of a system architecture for the system for performing electronic new product introductions.

### DETAILED DESCRIPTION OF THE INVENTION

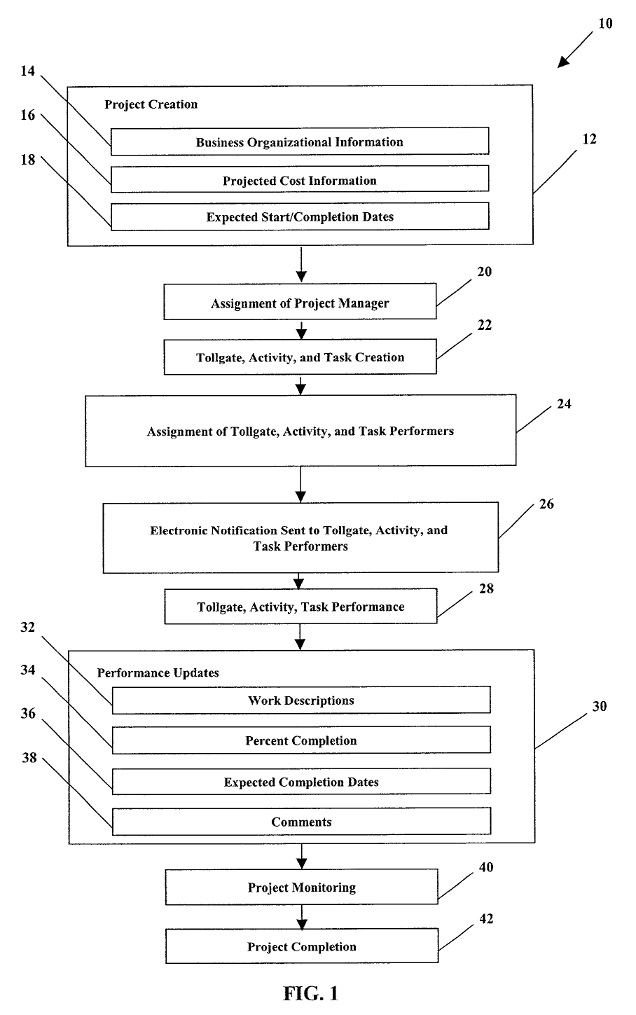

Referring to FIG. 1, in one embodiment, a computerized method 10 for performing new product introductions allows a project creator to log into a globally-accessible system and create a new project 12. The globally-accessible system preferably includes a webpage which contains a planning module. The webpage may be secure and include a plurality of dynamic menus, drop-down lists, links, and the like displayed on a graphical user interface. Through the webpage, a project creator, a project leader, a project manager, a team member, a task performer, or any other authorized remote user may view information, submit information, and query the system. Initially, the project creator may be required to enter project-related information, such as business organizational information 14, projected cost information 16, and expected start and completion dates 18. Once this information is entered, the new project is assigned to a project manager 20. Using the globally-accessible system, the project manager may learn to what project he or she has been assigned and he or she may create tollgates, activities, and tasks comprising the project 22. The relationship between tollgates, activities, and tasks is hierarchical and a project may have many tollgates, each of which may include many activities, each of which may include many tasks. The new tollgates, activities, and tasks may then be assigned to task performers 24. When a given tollgate, activity, or task is assigned to a task performer, the system may automatically send an electronic notification message, via Email or the like, to the task performer 26. The task performer may also view and query a list of newly assigned tollgates, activities, and tasks on the system webpage. As a result, tollgates, activities, and tasks may be assigned to task performers regardless of their location, or the location where work will be completed. The task performers may then work on their assigned tollgates, activities, and tasks 28, providing status reports or updates 30 when necessary via the globally-accessible system. Such updates may include, for example, work descriptions 32, percent completion 34, expected completion dates 36, actual start/completion dates, slip weeks, impact, and comments 38. Thus, the life cycle of a given tollgate or activity may be monitored and tracked 40, as well as the life cycle of a project itself 42. For example, color-coded scorecards, bar charts, and line graphs may be used to display the status of the tollgates, activities, and tasks associated with a given project.

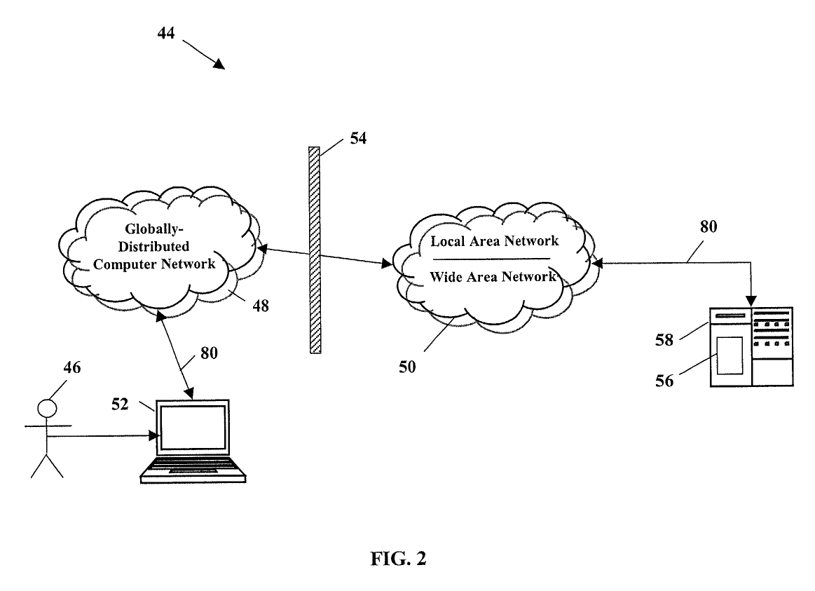

Referring to FIG. 2, in one embodiment, a computerized system 44 for performing new product introductions includes a remote user 46 linked to a project management website 56 via a globally-distributed computer network 48, such as the Internet or an intranet, and/or a local area network/wide area network (LAN/WAN) 50. This link may be established along one or more data communication lines 80 or via wireless interfaces. The remote user 46 may view and query information at the project management website 56 through a browser application run by a computer 52, such as a desktop or laptop personal computer. Through the project management website 56, the remote user 46 is linked, through a firewall 54, to a planning module which operates on project-related data. This project-related data may include information such as new product introduction information. The project management website 56 may reside in a persistent storage device 58, such as an application server, a database server, a file server, or a web server. The system 44 is set up such that the server 58 may communicate information to and acquire information from a plurality of remote users 46 simultaneously.

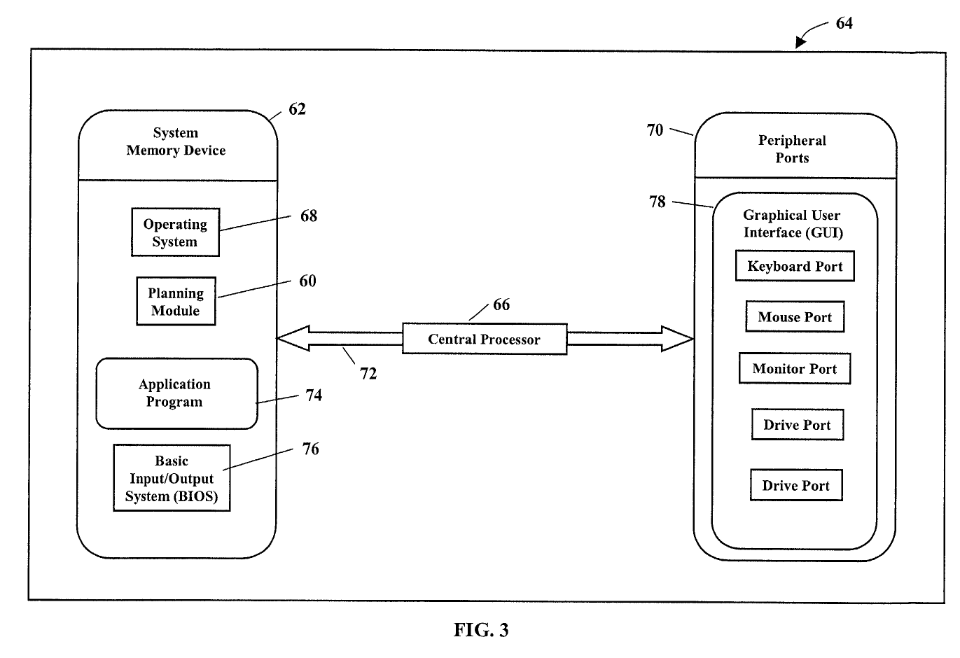

Referring to FIG. 3, in one embodiment, the planning module 60 comprises a computer program which acquires project-related data, stores and archives the data, manipulates the data, and formulates outputs which may be viewed and queried by the remote user 46 (FIG. 2). The planning module 60 preferably resides within the system memory device 62 of a computer system 64, which may, optionally, be an application server, a database server, a file server, or a web server. The system memory device 62 may include a random-access memory (RAM) and a read-only memory (ROM). The system memory device 62 may also include other types of memory, such as programmable read-only memory (PROM), erasable programmable read-only memory (EPROM), and electrically erasable programmable read-only memory (EEPROM). The memory also preferably includes an operating system 68 that executes on a central processor 66. The central processor 66 may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumburg, Ill.), International Business Machines Corp. (Armonk, N.Y.), and Transmeta Corp. (Santa Clara, Calif.). The central processor 66 may include an arithmetic logic unit (ALU), which performs arithmetic and logic operations, and a control unit, which extracts instructions from the system memory device 62. The operating system 68 may include a set of instructions which control the internal functions of the computer system 64. For example, the operating system 68 may recognize input from input devices, send output to output devices, keep track of files and directories, and control various peripheral devices. Suitable examples of operating systems 68 include, but are not limited to, those manufactured by Microsoft Corporation (Redmond, Wash.), Apple Computer, Inc. (Cupertino, Calif.), and Sun Microsystems, Inc. (Palo Alto, Calif.). A system bus 72 may communicate signals, such as address signals, data signals, and control signals, between the system memory device 62, the central processor 66, and one or more peripheral ports 70. The system memory device 62 may also contain an application program 74 and a basic input/output system (BIOS) 76. The application program 74 cooperates with the operating system 68 and the one or more peripheral ports 70 to provide a graphical user interface (GUI) 78. The GUI 78 typically includes a combination of signals communicated along a keyboard port, a mouse port, a monitor port, and one or more drive ports. The BIOS 76 may interpret requests from the operating system 68 and interface with such ports 70 to execute the requests. Accordingly, suitable input/output devices include a keyboard, a mouse, a monitor, a printer, a plotter, etc.

The systems, methods, programs, and processes described in relation to the present invention are not limited to any particular computer system. The computer system 64 may be a single device, or it may be a plurality of devices working in concert. The computer system 64 may take the form of a hand-held digital computer, a personal computer, a workstation, a server, a mainframe computer, and a supercomputer.

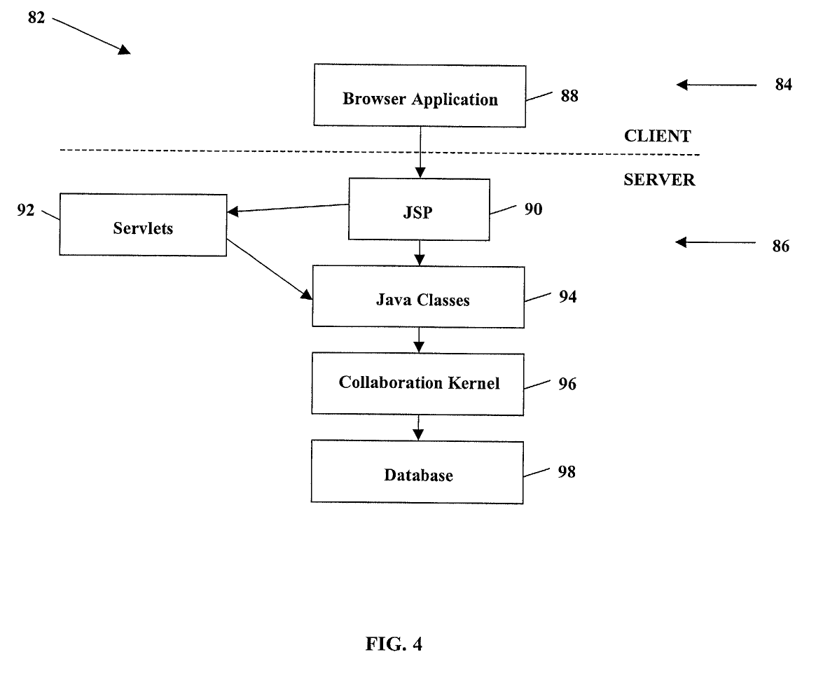

Referring to FIG. 4, in one embodiment, the system architecture 82 of the computerized system 44 (FIG. 2) for performing new product introductions includes a remote user/client portion 84 in communication with a server portion 86. The client portion 84 includes a browser application 88, such as a Hypertext Markup Language (HTML) or Extensible Markup Language (XML) browser. The system 44 is preferably set up such that webpages have limited graphics content, allowing remote users 46 (FIG. 2) connecting via dial-up modems or the like to download the pages rapidly. The speed of the system 44 may also be increased by caching large files, such as by storing cached data in a cache server. The server portion 86 allows project-related data to be published through applications such as active server pages (ASPs), Java server pages (JSPs) 90, and applets, such as Java applets and servlets 92. Further, the server portion 86 includes one or more Java classes 94 and a collaboration kernel 96. The collaboration kernel 96 interfaces the Java classes 94 or Java application with a relational database 98 for persistent storage. Finally, the system 44 is set up such that it may communicate with external scheduling, planning, project management, and database software/applications.

Functionally, the computerized system 44 (FIG. 2) for performing new product introductions allows for the planning, monitoring, tracking, and evaluation of the developmental and distributional life cycle of a product, including, for example, the identification of product options, the assessment of resource requirements, conceptual design, preliminary design, detailed design, production and design validation, and post-shipment follow up. In operation, the system 44 allows a remote user 46 (FIG. 2) to log into a secure webpage and create a project, view project summary information, view project detail information, search a project, and edit a project. The system 44 also allows the remote user 46 to add and edit tollgates, activities, tasks, and issues via the webpage, and update the status of each. Additionally, the system 44 allows the remote user 46 to check in/check out documents for a project, tollgate, activity, task, or issue via the webpage. Finally, the system 44 allows the remote user 46 to create and search a team, display the financial benefits of a project, update the total costs/benefits of a project, and update the expenses/benefits of a project via the webpage. The system 44 may, for example, perform costing or net present value (NPV) calculations. Each of the above items may be viewed with the aid of color-coded scorecards, bar charts, pie charts, line graphs, and similar visual aids.

In an exemplary embodiment, a webpage of the computerized system 44 (FIG. 2) for performing new product introductions may include a window, block, or portion listing critical tasks, the expected start/completion date of each, to whom each task is assigned, and the current status of the task. The current status of each task may be displayed, for example, as a percent completion number, a percent completion bar, or with the aid of a red-yellow-green (RYG) designation. The webpage may also include a portion listing team members and the extent to which they are currently being utilized, again as a percentage, a percentage bar, or with the aid of an RYG designation. The webpage may also include a portion allowing a project manager and team members to exchange project-related comments, optionally in real time. Finally, the webpage may include a portion displaying, for example, a line graph comparing estimated and actual budgets for a given period. Thus, a plurality of remote users 46 (FIG. 2) may simultaneously access, view, and update project information, and the system 44 allows the most current status of all project-related items to be immediately available to all remote users 46.

It is apparent that there has been provided, in accordance with embodiments of the present invention, web-based systems and methods for performing electronic new product introductions. While the present invention has been particularly shown and described in conjunction with preferred embodiments thereof, it will be appreciated that variations in and modifications to the present invention may be effected by persons of ordinary skill in the art without departing from the spirit or scope of the present invention. For example, the computerized systems and methods of the present invention may be used for assuring process compliance for a wide array of processes, not simply those related to new product introductions. Further, it is to be understood that the principles described herein apply in a similar manner, where applicable, to all preferred embodiments.

What is claimed is:

1. A computerized method for performing a project on a global basis, the method comprising:
creating the project using a globally-accessible system;
creating a plurality of tollgates, activities, and tasks associated with the project using the globally-accessible system;
selecting a plurality of individuals to perform the plurality of activities and tasks;
notifying the plurality of individuals which of the plurality of activities and tasks each has been selected to perform using the globally-accessible system;
collecting status information related to the plurality of tollgates, activities, and tasks from the plurality of individuals using the globally-accessible system;
communicating the status of the plurality of tollgates, activities, and tasks to the plurality of individuals using the globally-accessible system; and
monitoring the progress of the project using the globally-accessible system.

2. The method of claim 1, wherein the globally-accessible system further comprises a globally-distributed computer network.

3. The method of claim 2, wherein the globally-accessible system further comprises a local area network (LAN).

4. The method of claim 2, wherein the globally-accessible system further comprises a wide area network (WAN).

5. The method of claim 1, wherein the globally-accessible system further comprises a planning module operable for acquiring information related to the plurality of tollgates, activities, and tasks from the plurality of individuals, manipulating the information related to the plurality of tollgates, activities, and tasks, and communicating the information related to the plurality of tollgates, activities, and tasks to the plurality of individuals.

6. The method of claim 1, wherein notifying the plurality of individuals which of the plurality of activities and tasks each has been selected to perform using the globally-accessible system further comprises notifying the plurality of individuals which of the plurality of activities and tasks each has been selected to perform using Email.

7. The method of claim 1, wherein collecting status information related to the plurality of tollgates, activities, and tasks from the plurality of individuals using the globally-accessible system further comprises collecting at least one of work descriptions, percent completion, expected start/completion dates, actual start/completion dates, slip weeks, impact, and comments.

8. The method of claim 1, wherein communicating the status of the plurality of tollgates, activities, and tasks to the plurality of individuals using the globally-accessible system further comprises communicating the status of the plurality of tollgates, activities, and tasks to the plurality of individuals simultaneously.

9. The method of claim 8, wherein communicating the status of the plurality of tollgates, activities, and tasks to the plurality of individuals using the globally-accessible system further comprises communicating the status of the plurality of tollgates, activities, and tasks to the plurality of individuals using a plurality of color-coded visual aids.

10. The method of claim 1, wherein the project is a new product introduction project.

11. A computerized method for performing a new product introduction project on a global basis, the method comprising:
creating the project using a globally-accessible system;
creating a plurality of tollgates, activities, and tasks associated with the project using the globally-accessible system;
selecting a plurality of individuals to perform the plurality of activities and tasks;
notifying the plurality of individuals which of the plurality of activities and tasks each has been selected to perform using the globally-accessible system;
collecting status information related to the plurality of tollgates, activities, and tasks from the plurality of individuals using the globally-accessible system;
simultaneously communicating the status of the plurality of tollgates, activities, and tasks to the plurality of individuals using the globally-accessible system; and
monitoring the progress of the project using the globally-accessible system.

12. The method of claim 11, wherein the globally-accessible system further comprises a globally-distributed computer network, such as the Internet or an intranet.

13. The method of claim 12, wherein the globally-accessible system further comprises a local area network (LAN).

14. The method of claim 12, wherein the globally-accessible system further comprises a wide area network (WAN).

15. The method of claim 11, wherein the globally-accessible system further comprises a planning module operable for acquiring information related to the plurality of tollgates, activities, and tasks from the plurality of individuals, manipulating the information related to the plurality of tollgates, activities, and tasks, and communicating the information related to the plurality of tollgates, activities, and tasks to the plurality of individuals.

16. The method of claim 11, wherein notifying the plurality of individuals which of the plurality of activities and tasks each has been selected to perform using the globally-accessible system further comprises notifying the plurality of individuals which of the plurality of activities and tasks each has been selected to perform using Email.

17. The method of claim 11, wherein collecting status information related to the plurality of tollgates, activities, and tasks from the plurality of individuals using the globally-accessible system further comprises collecting at least one of work descriptions, percent completion, expected start/completion dates, actual start/completion dates, slip weeks, impact, and comments.

18. A computerized system for performing a project on a global basis, the system comprising:
a planning module operable for acquiring information related to a plurality of tollgates, activities, and tasks associated with the project from a plurality of individuals, storing the information related to the plurality of tollgates, activities, and tasks, and transferring the information related to the plurality of tollgates, activities, and tasks to the plurality of individuals;
a processor operable for manipulating the information related to the plurality of tollgates, activities, and tasks; and
a communications network operable for communicating the information related to the plurality of tollgates, activities, and tasks to and from the plurality of individuals.

19. The system of claim 18, wherein the communications network further comprises a globally-distributed computer network.

20. The system of claim 19, wherein the communications network further comprises a local area network (LAN).

21. The system of claim 19, wherein the communications network further comprises a wide area network (WAN).

22. The system of claim 18, wherein the planning module is operable for automatically electronically notifying the plurality of individuals which of the plurality of activities and tasks each has been selected to perform.

23. The system of claim 18, wherein the planning module is operable for acquiring and transferring information related to at least one of work descriptions, percent completion, expected start/completion dates, actual start/completion dates, slip weeks, impact, and comments.

24. The system of claim 18, wherein the planning module is operable for simultaneously communicating the status of the plurality of tollgates, activities, and tasks to the plurality of individuals.

25. The system of claim 18, wherein the project is a new product introduction project.

26. A computerized system for performing a new product introduction project on a global basis, the system comprising:
a planning module operable for acquiring information related to a plurality of tollgates, activities, and tasks associated with the project from a plurality of individuals simultaneously, storing the information related to the plurality of tollgates, activities, and tasks, and transferring the information related to the plurality of tollgates, activities, and tasks to the plurality of individuals simultaneously;
a processor operable for manipulating the information related to the plurality of tollgates, activities, and tasks; and
a communications network operable for communicating the information related to the plurality of tollgates, activities, and tasks to and from the plurality of individuals.

27. The system of claim 26, wherein the communications network further comprises a globally-distributed computer network, such as the Internet or an intranet.

28. The system of claim 27, wherein the communications network further comprises a local area network (LAN).

29. The system of claim 27, wherein the communications network further comprises a wide area network (WAN).

30. The system of claim 26, wherein the planning module is operable for notifying the plurality of individuals which of the plurality of activities and tasks each has been selected to perform using Email.

31. The system of claim 26, wherein the planning module is operable for acquiring and transferring information related to at least one of work descriptions, percent completion, expected start/completion dates, actual start/completion dates, slip weeks, impact, and comments.
